(19) United States
(12) Patent Application Publication
(10) Pub. No.: US 2026/0368845 A1
(43) Pub. Date: Nov. 19, 2026

(54) METHODS AND SYSTEMS FOR GENERATING FUSED OPERATOR FOR IMAGE RENDERING

(71) Applicant: Huawei Technologies Co., Ltd., Shenzhen (CN)

(72) Inventor: Shunguang Ding, Ottawa (CA)

(21) Appl. No.: 19/209,556

(22) Filed: May 15, 2025

(51) Int. Cl. G06T 1/20; G06F 8/34

(52) U.S. Cl. CPC G06T 1/20; G06F 8/34

(57) ABSTRACT

Methods and systems for combining multiple individual rendering operators into a single fused operator are described. For each of two or more individual rendering operators, a respective main function is identified. A set of fused code is generated by combining code of the two or more individual rendering operators. The fused code includes a fused main function that, when called, causes the respective main functions of the two or more individual rendering operators to be called in a sequence, where the output of a preceding individual operator is provided as input to an immediately following individual operator in the sequence. The two or more individual rendering operators are applied as a single fused operator by executing the fused main function.

### TECHNICAL FIELD

The present disclosure relates to methods and systems for image rendering, in particular generating a fused operator that combines multiple rendering operators.

### BACKGROUND

The field of rendering systems has evolved significantly over the past few decades, driven by the increasing demand for higher quality and real-time performance in applications like video games, virtual reality, and advanced simulations. These applications typically require high performance rendering, meaning that rendering systems should be capable of generating frames at high frame rate, with realistic visual effects such as complex shading, lighting, etc., and be capable of adapting to changing conditions such as dynamic lighting, moving objects, changing camera angles, etc.

Conventional rendering systems typically have inefficiencies in task execution and resource utilization, which hinder performance in dynamic and complex environments.

Accordingly, there is a need for improvements in rendering systems.

### SUMMARY

Some embodiments of the present disclosure include one or more of the following features, which can be separately adopted, or work together as a complete solution.

In various examples, the present disclosure describes methods and systems for generating a fused rendering operator, which may be useful for improving the performance of rendering systems. Examples of the present disclosure enable two or more rendering operators to be combined into a single fused operator, enabling two or more rendering tasks to be performed together (e.g., applying lighting and shadowing effects in a single pass). This may provide the technical advantage that redundant memory usage and processes (e.g., loading and processing the same data multiple times) can be reduced, leading to more efficient memory usage and reduced processing time. Another technical advantage is that, when implemented in a parallel computing environment, combining multiple individual rendering operations into a single fused operator allows the system to execute fewer, larger tasks in parallel, which may help to improve the utilization of available resources (e.g., graphics processing unit (GPU) cores or compute units). Another technical advantage is that data dependencies between operations may be more effective managed when fused operators are used, which may help to reduce latency and/or increase throughput. In some examples, certain hardware, such as GPUs or custom hardware accelerators (e.g., ray tracing cores), can benefit from fused operators by simplifying the execution flow. Such accelerators are typically optimized for specific tasks, and a fused operator may be more effectively executed than conventional single operator execution.

Examples of the present disclosure enable a rendering system to optimize performance of fused operator tasks, by monitoring task execution and adjusting the strategy for generation of fused operators as appropriate. This provides the technical advantage that the system performance can be monitored and optimized dynamically, in real-time, to enable more efficient usage of available system resources.

Additional details of the disclosed examples and technical advantages thereof will be described further below.

In an example aspect, the present disclosure describes a method including: identifying, for each of two or more individual rendering operators, a respective main function; generating a set of fused code by combining code of the two or more individual rendering operators, the fused code including a fused main function that, when called, causes the respective main functions of the two or more individual rendering operators to be called in a sequence, the output of a preceding individual operator being provided as input to an immediately following individual operator in the sequence; and causing the two or more individual rendering operators to be applied as a single fused operator by executing the fused main function.

In an example of the preceding example of the method, the method may include receiving a rendering task request, the rendering task request including requests to execute the two or more individual rendering operators; wherein the identifying is performed responsive to receiving the rendering task request.

In an example of the preceding example of the method, the rendering task request may define the sequence in which the respective main functions of the two or more individual rendering operators are called in the fused code.

In an example of a preceding example of the method, the method may include: storing the generated fused code; receiving a rendering task request, the rendering task request including requests to execute the two or more individual rendering operators; wherein the generated fused code is retrieved and used to cause the two or more individual rendering operators to be applied as the single fused operator, responsive to receiving the rendering task request.

In an example of the preceding example of the method, the rendering task request may define the sequence in which the two or more individual rendering operators are to be called, and the generated fused code may be retrieved in response to a query for the two or more individual rendering operators ordered according to the sequence.

In an example of any of the preceding examples of the method, generating the set of fused code may include: modifying a function name or a variable name of at least one of the two or more individual rendering operators to be unique within the fused code.

In an example of any of the preceding examples of the method, the method may include: validating the fused code by executing the fused main function using validation image data as input and comparing output of the fused main function with expected validation output.

In an example of any of the preceding examples of the method, the method may include: comparing execution of the fused main function with one or more target performance thresholds; determining that at least one target performance threshold is not met; and adjusting a fusion strategy used for generating the fused code.

In an example of the preceding example of the method, adjusting the fusion strategy may be one of: adjusting a number of individual rendering operators combined into the fused code, adjusting the sequence in which the respective main functions of the two or more individual rendering operators are called within the fused code, or adjusting a selection of individual rendering operators combined into the fused code.

In another example aspect, the present disclosure describes a computing system including a non-transitory memory; and a processing unit configured to execute instructions stored in the non-transitory memory to cause the system to: identify, for each of two or more individual rendering operators, a respective main function; generate a set of fused code by combining code of the two or more individual rendering operators, the fused code including a fused main function that, when called, causes the respective main functions of the two or more individual rendering operators to be called in a sequence, the output of a preceding individual operator being provided as input to an immediately following individual operator in the sequence; and cause the two or more individual rendering operators to be applied as a single fused operator by executing the fused main function.

In an example of the preceding example of the system, the instructions may further cause the system to: receive a rendering task request, the rendering task request including requests to execute the two or more individual rendering operators; wherein the identifying is performed responsive to receiving the rendering task request.

In an example of the preceding example of the system, the rendering task request may define the sequence in which the respective main functions of the two or more individual rendering operators are called in the fused code.

In an example of a preceding example of the system, the instructions may further cause the system to: store the generated fused code; receive a rendering task request, the rendering task request including requests to execute the two or more individual rendering operators; wherein the generated fused code is retrieved and used to cause the two or more individual rendering operators to be applied as the single fused operator, responsive to receiving the rendering task request.

In an example of the preceding example of the system, the rendering task request may define the sequence in which the two or more individual rendering operators are to be called, and the generated fused code may be retrieved in response to a query for the two or more individual rendering operators ordered according to the sequence.

In an example of any of the preceding examples of the system, the instructions may cause the system to generate the set of fused code by: modifying a function name or a variable name of at least one of the two or more individual rendering operators to be unique within the fused code.

In an example of any of the preceding examples of the system, the instructions may further cause the system to: validate the fused code by executing the fused main function using validation image data as input and comparing output of the fused main function with expected validation output.

In an example of any of the preceding examples of the system, the instructions may further cause the system to: compare execution of the fused main function with one or more target performance thresholds; determine that at least one target performance threshold is not met; and adjust a fusion strategy used for generating the fused code.

In an example of the preceding example of the system, adjusting the fusion strategy may be one of: adjusting a number of individual rendering operators combined into the fused code, adjusting the sequence in which the respective main functions of the two or more individual rendering operators are called within the fused code, or adjusting a selection of individual rendering operators combined into the fused code.

In another example aspect, the present disclosure describes a non-transitory computer readable medium storing instructions thereon, wherein the instructions are executable by a processing unit of a computing system to cause the system to: identify, for each of two or more individual rendering operators, a respective main function; generate a set of fused code by combining code of the two or more individual rendering operators, the fused code including a fused main function that, when called, causes the respective main functions of the two or more individual rendering operators to be called in a sequence, the output of a preceding individual operator being provided as input to an immediately following individual operator in the sequence; and cause the two or more individual rendering operators to be applied as a single fused operator by executing the fused main function.

In an example of the preceding example aspect of the computer readable medium, the instructions, when executed by a processing unit of a system, may cause the system to perform any of the preceding example aspects of the method.

In another example aspect, the present disclosure describes a processing module configured to control a computing system to cause the system to carry out any of the preceding example methods.

In another example aspect, the present disclosure describes a chip or a chipset comprising a processor configured to execute instructions to cause a computing system to carry out any of the preceding example methods.

In another example aspect, the present disclosure describes a computer program characterized in that, when the computer program is run on a computer, the computer is caused to execute any of the preceding example methods.

### BRIEF DESCRIPTION OF THE DRAWINGS

Reference will now be made, by way of example, to the accompanying drawings which show example embodiments of the present application, and in which:

FIG. 1 is a block diagram illustrating an example computing system, which may be used to implement examples of the present disclosure;

FIG. 2 is a schematic diagram illustrating an example system architecture, in accordance with examples of the present disclosure;

FIG. 3 is an example process flow, in accordance with examples of the present disclosure;

FIG. 4 is a flowchart illustrating an example method for generating a fused operator, in accordance with examples of the present disclosure;

FIG. 5 shows example code for two example individual rendering operators; and

FIG. 6 shows example code for an example fused operator generated by combining the individual rendering operators shown in FIG. 5.

Similar reference numerals may have been used in different figures to denote similar components.

### DETAILED DESCRIPTION OF ILLUSTRATIVE EMBODIMENTS

A challenge in conventional rendering systems, especially in real-time graphics applications, is that conventional rendering systems often face performance bottlenecks due to independent task execution, resource contention and/or inefficient use of parallelism.

For example, rendering operations such as shading, lighting, texturing, and post-processing are conventionally executed as independent tasks. This can lead to redundant processing of the same data (e.g., the same data might be loaded and processed multiple times across different stages or processing units), leading to unnecessary memory usage, unnecessary re-computations, and extended processing times. Many rendering operations depend on the same intermediate data (e.g., lighting data is used for both shadow rendering and color rendering). When these rendering operations are executed as isolated tasks in conventional rendering systems, the same intermediate data needs to be accessed and processed twice, resulting in redundancy and inefficiencies.

As well, because conventional rendering systems treat each rendering operation as an isolated task, interdependencies between tasks (e.g., rendering of lighting effects and rendering of shadow effects) are not recognized, resulting in resource contention in which the same resources may be used by multiple tasks simultaneously, causing delays and inefficiencies.

Examples of the present disclosure enable individual rendering operations to be combined into a single fused operator that can be executed as a single task, thus reducing the number of data passes and helping to improving the efficiency of the rendering system.

Examples of the present disclosure may also include real-time resource management to allocate tasks to computational resources in an adaptive manner (e.g., adjusting to fluctuating resource demands such as in gaming or real-time rendering applications). In some examples, the present disclosure may enable the overall performance of the system to be monitored, and adaptive optimization may be used to maintain system performance. For example, the strategy for fusing operators and/or resource allocation may be adjusted dynamically.

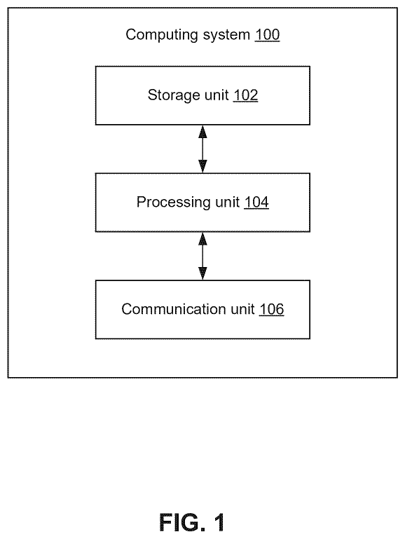

FIG. 1 is a block diagram of an example computing system 100, which may be used to implement examples of the present disclosure. The example computing system 100 may, for example, be a desktop computer, a workstation, a laptop, a terminal, etc. In some examples, the computing system 100 may be a module or subsystem within a larger rendering system. FIG. 1 intended to be illustrative, and examples of the present disclosure may be implemented using other types of computing systems, which may include components different from those discussed below. Although FIG. 1 shows a single instance of each component, there may be multiple instances of each component in the

### Computing System 100

The computing system 100 may include corresponding modules or units configured to implement methods and/or implementations described herein. In the example shown, the computing system 100 includes a processing unit 104 and a communication unit 106. The computing system 100 may further include a storage unit 102 configured to store apparatus program code (or instructions) and/or data (such as instructions for carrying out examples disclosed herein).

The processing unit 104 may be one or more processors such as a modem chip, a System on a Chip (SoC) or a System in Packet (SiP), among other possibilities. In some examples, the processing unit 104 may be implemented by a circuit system which may include one or more processors. A processor may be referred to as a processor system, an application processor, a baseband processor, a processor circuit, or a processor core. The processor may include one or a combination of one or more central processing units (CPUs), one or more digital signal processors (DSPs), one or more microprocessors (microprocessor units, MPUs), one or more microcontrollers (microcontroller units, MCUs), one or more graphics processing units (GPUs), or one or more field programmable gate arrays (FPGAs).

The communication unit 106 may include wireless transmitters and/or receivers (or transceivers). In some examples, the communication unit 106 may be implemented by an interface circuit.

The storage unit 102 may be a memory. A memory or a storage unit may include one or more of the following storage media: a random access memory (RAM), a static random access memory (static RAM, SRAM), a dynamic random access memory (dynamic RAM, DRAM), a phase-change memory (PCM), a resistive random access memory (resistive RAM, ReRAM), a magnetoresistive random access memory (magnetoresistive RAM, MRAM), a ferroelectric random access memory (ferroelectric RAM, FRAM), a cache, a register, a read-only memory (ROM), a flash memory (flash memory), an erasable programmable read-only memory (erasable programmable ROM, EPROM), a hard disk, and the like. The storage unit 102 may store instructions that are executable by the processing unit 104, to perform one or more examples of the present disclosure.

In an example, computer program instructions used to execute implementations may be stored in a non-volatile memory, for example, at least a part of a memory or storage unit (for example, one or more of a ROM, a flash memory, an EPROM, or a hard disk). When the computing system 100 runs, a part or all of corresponding computer program instructions may be loaded to a memory that has a higher transmission speed with the processor, for example, at least a part of a memory or a storage unit (for example, one or more of a RAM, an SRAM, a DRAM, a PCM, a RERAM, an MRAM, a FRAM, a cache, or a register), so that the processor executes the computer program instructions to perform the steps in the example method implementations disclosed herein.

It should be understood that the units 102, 104, 106 in the computing system 100 may be a combination of logical units and functional units. For example, each function may correspond to one functional unit, or two or more functions may be integrated into a single functional unit. In actual implementation, all or some of the units may be integrated into a single physical entity, or may be distributed across different physical entities. In addition, the functional units may be implemented in the form of hardware, software, or a combination of hardware and software. Whether a function is implemented in the form of hardware or software depends on particular applications and design constraint conditions of the technical solutions. A person skilled in the art may use different methods to implement the described functions for specific applications, but it should not be considered that the implementation goes beyond the scope of this disclosure.

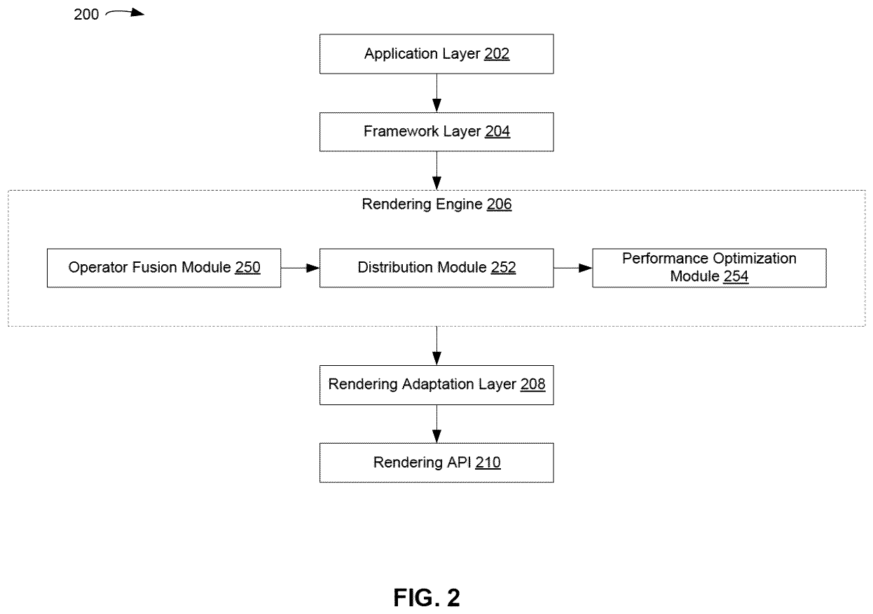

FIG. 2 is a schematic diagram of an example system architecture 200, which may be used to implement examples of the present disclosure. The example system architecture 200 may be implemented in the computing system 100, for example, or other suitable rendering system. The system architecture 200 may be designed to provide modularity, scalability and/or adaptability, and is not platform-specific or system-specific. It should be understood that the system architecture 200 illustrated in FIG. 2 is only illustrative and is not intended to be limiting.

The system architecture 200 includes an application layer 202, a framework layer 204, a rendering engine 206, a rendering adaptation layer 208 and a rendering application program interface (API) 210.

The application layer 202 enables user interactions with the overall system. Any application that may invoke rendering tasks may be on the application layer 202. The application layer 202 is responsible for initiating rendering tasks and enables interactions with users or other user-facing engines (e.g., game engines). The application layer 202 provides rendering task initiation, supports user interactions (e.g., providing outputs and receiving inputs) and invoking the rendering API 210, among other functions.

The framework layer 204 is responsible for providing communication between the application layer 202 and the rendering engine 206. The framework layer 204 provides task scheduling, rendering configuration (e.g., managing configurations such as quality settings, effect options, etc.) and interface management, among other functions.

The rendering engine 206 is responsible for executing rendering tasks and managing rendering operations, such as scheduling rendering tasks and managing rendering techniques (e.g., rasterization, ray tracing, etc.). The rendering engine 206 includes an operator fusion module 250, and may also include a distribution module 252 and performance optimization module 254.

The operator fusion module 250 is responsible for fusing two or more individual rendering operators (for performing respective two or more individual rendering tasks) into one fused operator. The operator fusion module 250 may generate a fused operator at runtime (e.g., as individual rendering operators are called) and/or during precompile (e.g., prior to any rendering operators being called). The operator fusion module 250 may store generated fused operators (e.g., in a local memory of the rendering engine 206 or in another storage of the computing system 100) and may obtain a previously generated fused operator from memory as needed instead of generating a fused operator each time. The operator fusion module 250 identifies individual rendering operators to be fused (e.g., blurring operator, grayscale operator, contrast adjustment operator, etc.), combines the individual operators and outputs the fused operator. The operator fusion module 250 outputs a fused operator task (in which two or more individual rendering tasks are executed as a single task) to be executed.

The fused operator task may be passed to the distribution module 252, which allocates tasks to appropriate execution units based on the system's overall resource availability and load (e.g., CPU/GPU usage). The distribution module 252 may perform functions such as load balancing, resource allocation and dynamic task reassignment. For example, the distribution module 252 may split a rendering task into smaller chunks that are assigned to different GPUs based on the load and availability of each GPU.

The performance optimization module 254 may monitor task performance and make adjustments in real-time, including adjusting the fusion strategy where necessary. The performance optimization module 254 may track performance metrics such as processing time, resource utilization, task completion rates, etc. The performance optimization module 254 may select from different defined fusion strategies in order to make adjustments. For example, if the performance optimization module 254 determines that a given fused operator task is exceeding a time limit, the performance optimization module 254 may adjust the fusion strategy to reduce the number of individual operators that are combined into a single fused operator. The performance optimization module 254 may then provide feedback to the operator fusion module 250 to adjust the operator fusion.

The rendering adaptation layer 208 is responsible for adapting the rendering for various hardware and/or platforms. For example, the rendering adaptation layer 208 may provide hardware abstraction, compatibility management (e.g., to ensure compatibility with various API types) and performance optimization for different types of hardware.

The rendering API 210 is responsible for providing an interface for the application layer 202 to invoke rendering tasks and interface with the rendering engine 206. For example, the rendering API 210 may provide an interface for task execution, and may support various different API types.

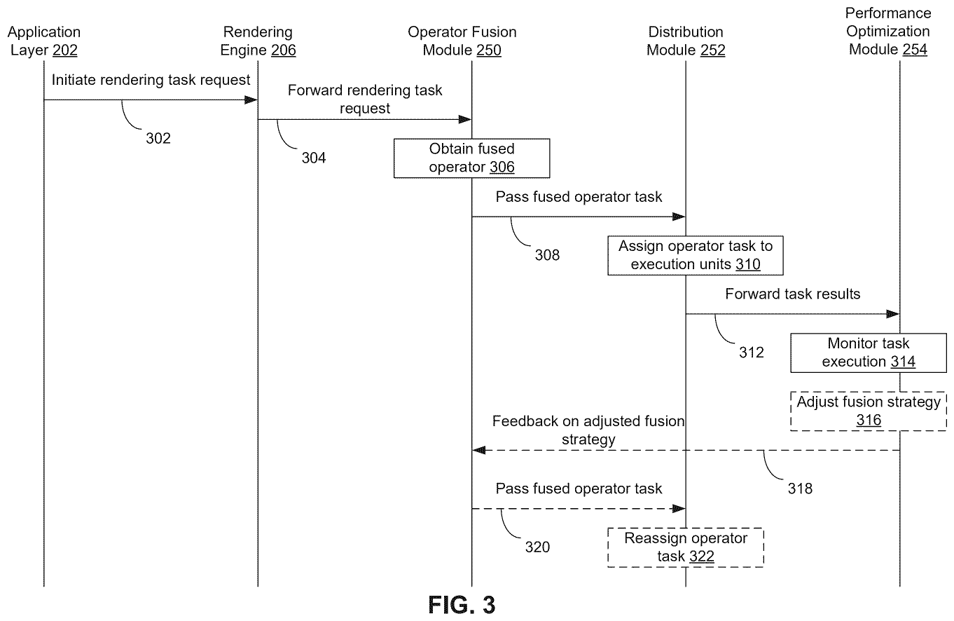

FIG. 3 is a schematic diagram of an example process flow, which illustrates an example of how a rendering task may be carried out by the computing system 100, using the system architecture 200 described above. For simplicity, the framework layer 204, rendering application layer 208 and rendering API 210 are omitted from the process flow of FIG. 3. It should be understood that this is only illustrative and not intended to be limiting.

The example process flow begins at 302 with the application layer 202 initiating a rendering task request to the rendering engine 206. For example, the rendering task request may be for an image rendering task, video processing task or graphical effects task, and may involve a combination of different rendering tasks.

At 304, the rendering engine 206 receives the rendering task request and forwards the rendering task request to the operator fusion module 250. Generally, the rendering engine 206 may perform high-level task management and schedule. The rendering engine 206 may forward the rendering task request to the operator fusion module 250 in order to better optimize the rendering task.

At 306, the operator fusion module 250 obtains a fused operator corresponding to the rendering task request. The fused operator may be obtained by the operator fusion module 250 retrieving the fused operator from storage (e.g., a local memory or other storage of the computing system 100). For example, the operator fusion module 250 may identify that the rendering task request involves a blurring operator and a shading operator, and may query the storage for a fused operator that combines blurring and shading (e.g., by using a query string such as “blurring+shading”). If a suitable fused operator can be retrieved from storage, the operator fusion module 250 may use the retrieved fused operator to perform a fused operator task.

The operator fusion module 250 may generate the fused operator (e.g., if a suitable fused operator cannot be found in storage). The operator fusion module 250 performs operations to analyze the rendering task and identify two or more operators that are fusion candidates. The operator fusion module 250 may identify two or more individual rendering operators that are compatible with each other (e.g., rendering operators that are interdependent may be candidates for fusion, rendering operators that use the same intermediate data may be candidates for fusion, etc.). The individual rendering operators that can be fused together may be predefined. For example, blurring and color adjustment operators may be predefined as compatible operators that can be candidates for fusion. In some examples, it may be assumed that all individual rendering operators are candidates for fusion (e.g., it may be assumed that developers have created rendering operators within guidelines that ensure compatibility for fusion). The operator fusion module 250 performs operations to combine the two or more individual rendering operators into a fused operator, details of which will be discussed further below.

Regardless of how the fused operator is obtained, the operator fusion module 250 at 308 passes the fused operator task to the distribution module 252. The distribution module 252 is responsible for task scheduling and distribution. At 310, the distribution module 252 assigns the fused operator task to appropriate execution units. This may involve the distribution module 252 assessing the current load on available resources (e.g., available GPUs or CPUs), then performing load balancing to distribute tasks efficiently across the available resources (e.g., based on which units are underutilized or overburdened). The fused operator task is processed by the assigned execution units and results are generated. Depending on the complexity, the assigned execution units may perform several computations in parallel. The results are returned to the distribution module 252 after processing.

At 312, the distribution module 252 forward the results of task execution to the performance optimization module 254.

The performance optimization module 254, at 314, monitors key performance indicators for the task, such as execution time, resource usage (e.g., GPU or CPU usage, memory consumption, etc.) and latency, to evaluate how efficiently the task was processed by the execution units.

Optionally, if the performance analysis indicates inefficiencies or suboptimal performance (e.g., execution time exceeds a defined time limit, resource usage exceeds a defined usage amount, etc.), the performance optimization module 254 may, at 316, adjusts the fusion strategy. The performance optimization module 254 may have a number of predefined fusion strategy from which a new fusion strategy may be selected. For example, the fusion strategy may be adjusted by adjusting the number of individual rendering operators that are combined into the fused operator (e.g., if the execution time for the fused operator task exceeds the defined time limit, the performance optimization module 254 may adjust the fusion strategy to reduce the number of individual operators that can be combined). In another example, the fusion strategy may be adjusted by adjusting the order that individual rendering operators are executed in the fused operator, which may help to improve resource utilization. For example, adjusting the order in which individual rendering operators are executed may help to improve performance by making better use of faster memory (e.g., cache), reducing data transfers and/or allowing some operations to run in parallel, among other improvements. For example, if color adjustment and blur are individual rendering operators combined in the fused operator, adjusting the order such that color adjustment is applied before blur may help to reduce the amount of data required to be processed, thus improving performance.

The performance optimization module 254 may adjust the fusion strategy in other ways, such as adjusting the fusion strategy to combine similar operators in the fused operator (e.g., brightness operator and contrast operator may be combined), adjusting the fusion strategy to omit unnecessary steps in the fusion operator (e.g., if an approximation may be used instead of an exact calculation), adjusting the fusion strategy to replace certain code blocks in the fused code with pre-optimized code blocks, or adjusting the fusion strategy based on availability of hardware features such as GPU or ray tracing units, among other possibilities. The performance optimization module 254 may store rules for adjusting the fusion strategy, and the performance optimization module 254 may select an appropriate rule to apply based on, for example, data size, hardware availability and/or past performance.

If the fusion strategy is adjusted, then at 318 the performance optimization module 254 may send feedback to the operator fusion module 250 to indicate the adjusted fusion strategy. For example, the performance optimization module 254 may instruct the operator fusion module 250 to use an indicated fusion strategy from among a plurality of defined fusion strategies. The operator fusion module 250 then updates the fusion strategy accordingly. In this way, there may be feedback provided to the operator fusion module 250 so that the generation of fused operator can be adaptive and responsive to actual system performance, which may help to improve overall system efficiency in real-time. The operator fusion module 250 updates the fusion strategy such that the adjusted fusion strategy will be used for generating a fused operator the next time the same or similar rendering task request is received.

Based on the feedback and any adjustments made by the performance optimization module 254, the operator fusion module 250 updates the fused operator task. The operator fusion module 250 may use the adjusted fusion strategy for updating the fused operator task for the next same or similar rendering task request. For example, if the performance optimization module 254 provided feedback based on evaluation of the performance of a fused operator task that combined blur and shading rendering operators, then the operator fusion module 250 may use the provided feedback to adjust the fusion strategy the next time a rendering task request is received that includes blur and shading rendering operators. It may be noted that the adjusted fusion strategy may not be universally applied to all subsequent rendering task requests (e.g., an adjusted fusion strategy based on evaluation of a fused operator task combining blur and shading may not be applied for an unrelated rendering task such as contrast and shading).

The operator fusion module 250, at 320, passes the updated fused operator task to the distribution module 252, which reassesses the available resources and, if appropriate, reassigns the operator task to other execution units at 322.

The performance optimization module 254 may thus provide feedback that helps to improve system performance by dynamically adjusting how fused operators are generated, and the distribution module 252 may dynamically adjust resource allocation according to the updated fused operator task.

The process flow illustrated in FIG. 3 may be performed for each rendering task request received from the application layer 202. Results of the rendering task may be returned to the application layer 202 to be outputted (e.g., as an output image, video frame, graphical effect, etc.)

Details of generating a fused operator (e.g., by the operator fusion module 250) are now discussed. The process of generating a fused operator from two or more individual rendering operators should take into account which operators can be logically combined (e.g., based on predetermined lists of operators that can be combined), consider the sequence in which individual rendering operators are called within the fused operator (e.g., a fused operator that calls blur followed by shading operators may be considered to be different from another fused operator that calls shading followed by blur operators) and avoid conflicts (e.g., as a result of non-unique variable names used in two or more individual rendering operators being confused in the fused operator). Combining multiple individual rendering operations into a single, streamlined fused operator may help to reduce computational overhead, minimize redundant calculations, and may help to improve the overall performance of the system.

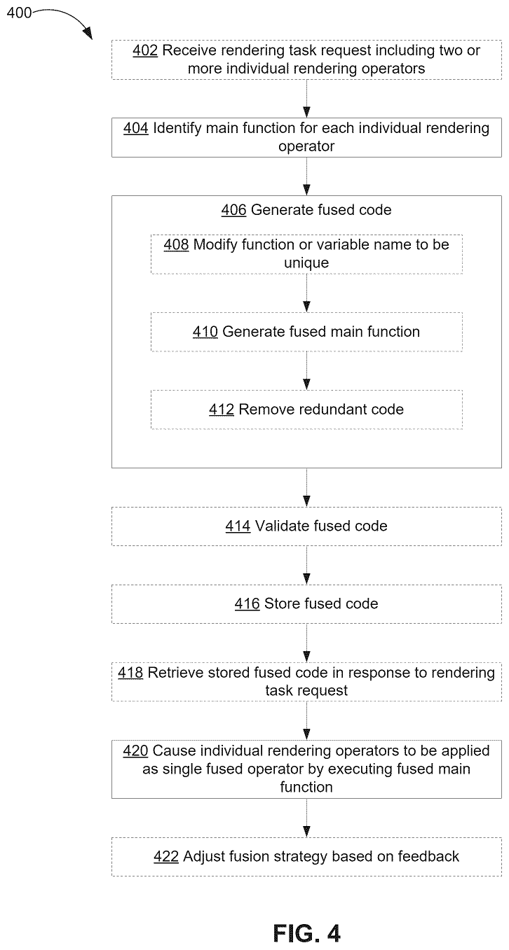

FIG. 4 is a flowchart illustrating an example method 400 for generating a fused operator, in accordance with examples of the present disclosure. The example method 400 may be performed by a computing system (e.g., the computing system 100 of FIG. 1) executing instructions to implement an operator fusion module 250 as described above. In some examples, the method 400 may be performed as part of a larger process flow, such as that illustrated in FIG. 3.

In some examples, the method 400 may be used to generate a fused operator during runtime, for example in response to receiving a rendering task request at runtime (e.g., performed dynamically during execution of an application). In some examples, the method 400 may be used to generate a fused operator prior to runtime (e.g., at precompile) and the generated fused operator may be stored and retrieved later to be used at runtime.

If the method 400 is performed at runtime, then at 402 a rendering task request may be received (e.g., from the application layer 202). The rendering task request may include requests to call two or more individual rendering operators. The rendering task request may request the two or more individual rendering operators to be called in a particular order or sequence (e.g., the rendering task request may specify a blur operator to be followed by a grayscale operator). If the method 400 is performed prior to runtime, step 402 may be omitted.

At 404, a respective main function is identified for each of the two or more individual rendering operators. Each individual rendering operator may be analyzed (e.g., the code may be parsed by a parser of the operator fusion module 250) to identify the main function (also referred to as the main entry point), which is the function that is conventionally called in order to invoke that individual rendering operator. Typically, the main function in each operator is indicated according to a known syntax or convention (e.g., indicated by a keyword such as “main” or similar, according to known syntax or convention), such that the main function may be readily identified by parsing the code of the individual rendering operator according to the known syntax or convention. For example, the main function for the individual blur operator may be denoted as main_blur( ) and the main function for the individual grayscale operator may be denoted as main_grayscale( ).

Each individual rendering operator may be also analyzed to identify, for example, the input parameter(s) required and the output(s) generated. This may help to ensure that, when combined into a single fused operator, the output(s) generated by one operator within the fused operator may be used as the input(s) for a subsequent operator within the fused operator. Analyzing the input(s) and output(s) of each individual rendering operator may also help to ensure that the sequence in which the individual operators are combined within the fused operator is logical (e.g., the output(s) of a preceding operator can be directly used as input(s) of the following operator in the sequence). The analysis may thus identify any interdependencies between individual rendering operators, and may define the sequence of the individual rendering operators within the fused operator, to ensure the interdependencies are respected.

In some examples, there may be predetermined rules and/or dependency graphs that identify interdependencies and that may be used to define which individual rendering operators can be combined into a fused operator and in what sequence. For example, different possible combinations of standard rendering tasks such as blur, grayscale, sharpening or lighting may be defined ahead of time, as well as the permitted sequence in which these tasks may be combined, which may help to simplify the analysis performed at step 404 and reduce the processing time at this step.

At 406, a set of fused code is generated. The fused code is generated by combining the code of the two or more individual rendering operators. In particular, the fused code is generated such that the fused code includes a fused main function that, when called, causes the respective main functions of the two or more individual rendering operators (identified at step 404) to be called in sequence (which may be defined by the rendering task request optionally received at step 402). In the fused code, the output of a preceding individual operator is provided as input to an immediately following individual operator in the sequence. The generation of the fused code may be performed using one or more of steps 408, 410 and/or 412 described below.

Optionally, at 408, a function name or a variable name of at least one of the two or more individual rendering operators may be modified so as to be unique within the fused code. Modifying function or variable names in this way may help to avoid conflicts in the fused code (e.g., two individual rendering operators may use the same variable name, which would result in conflict if combined in the fused code). A function or variable name may be modified using a defined convention that ensures uniqueness. For example, the names of all variables within a given individual rendering operator may be modified by appending the name of the individual rendering operator (e.g., the variable “color” within the function blur( ) may be modified to “blur_color”, and the variable “color” within the grayscale( ) may be modified to “grayscale_color”, so as to be distinct from each other). In another example, the name of the respective main function of each individual rendering operator may be modified to avoid overlapping with other operators, such as by appending “fused” such that blur( ) becomes fused_blur( ). In some examples, step 408 may be omitted, such as when the parser of the operator fusion module 250 does not detect any overlapping function or variable names.

The code of the individual rendering operators are combined into one set of fused code. This may be done by simply concatenating the code of the individual rendering operators together in sequence. As described above, the sequence in which to combine the individual rendering operators within the fused code may be defined by a rendering task request, may be in accordance with predetermined rules, and/or may be based on analyzing the logic of the individual rendering operators.

Modifying the names of the functions and variables at step 408 may help to ensure there are no conflicting operations in the combined fused code. In some examples, instead of simply concatenating the code of the individual rendering operators together in sequence, the fused code may be arranged to help with readability (e.g., in case validation by a human is later required). For example, the code of each individual rendering operator typically is organized into different section types (e.g., one section type may define variables and another section type may contain side functions). The code of the individual rendering operators may be combined into the fused code such that code sections of the same type are grouped together in the fused code. Identifying code sections may be done by the parser of the operator fusion module 250 (e.g., based on recognizing known syntax or conventions used to identify the different types of code sections), for example, and the identified code sections that are of the same type may then be grouped together in the fused code.

At 410, a fused main function is generated. The fused main function provides a single entry point that can be used to call the fused operator, to cause the individual rendering operators within the fused operator to be executed in sequence. The fused main function may be generated using a predefined template (which may be stored at the operator fusion module 250). The predefined template may be designed to ensure consistency in the code and to include necessary code components such as function signatures, control flow and integration with other fused operators. The template may be customized to specific requirements of an application (e.g., input/output types, optimization constraints, etc.). For example, the fused main function may use the following template in the case where two individual rendering operators are combined:
void fused_main(“input”) {
“operator 1”
“operator 2”
setOutput(“output”); //Output the final color after both operations
}

In the above template, the placeholder “input” may be replaced with the name of the inputs of the first individual rendering operator in the sequence, the placeholders “operator 1” and “operator 2” may be replaced with the renamed main functions of the two individual rendering operators that are combined into the fused code, and the placeholder “output” may be replaced with the name of the outputs of the second individual rendering operator in the sequence.

Using this example template, if the fused operator combines a blur operator and a grayscale operator, the fused main function may be as follows:
void fused_main(float2 coord) {
   float radius=5.0;
   float4 blurredColor=fused_blur(coord, radius); //Apply blur first
   float4 finalColor=fused_grayscale(blurredColor); //Then apply grayscale
   setOutput(finalColor); //Output the final color after both operations
}

In the above example, the fused main function causes execution of the blur operator followed by the grayscale operator, where the output of the blur operator is passed as input to the grayscale operator, and the output of the grayscale operator is the final output of the fused operator.

Optionally, at 412, redundant code may be removed. For example, if the code for two different individual rendering operators each includes code for accessing the same intermediate data, the second instance of this code (which would be redundant) may be removed. Identification and removal of redundant code may be performed by analyzing the code that has been combined in the fused code and identifying any duplicated lines of code. For example, a parse or static analysis tool may be used to identify redundant code. In an example, a parser of the operator fusion module 250 may be used to break down the code into an abstract syntax tree (AST), and static analysis tools may be used to detect duplicate patterns, unused variables and/or redundant logic by comparing nodes of the AST and evaluating their necessity. In some examples, the operator fusion module 250 may implement analysis techniques such as data-flow analysis and control-flow analysis to further identify unreachable or equivalent code segments. The identified redundant code may then be automatically removed by refactoring or optimization passes, for example. It should be noted that by performing step 408 to ensure uniqueness of function and variable names, it can be ensured that any lines of code that are duplicated in the fused code are truly redundant and the duplicate can be removed.

The fused code may be further optimized for performance. For example, if the fused code includes constants, the constants may be identified (e.g., a parser may identify constants based on syntax) the operator fusion module 250 may precompute these constants to reduce latency at runtime. Other techniques for code optimization may be used.

After the fused code is generated, optionally, at 414, the fused code may be validated. The fused code may be validated by executing the fused main function using validation image data as input and comparing output of the fused main function with the expected validation output. The output generated by the fused main function may be automatically compared with the expected validation output (e.g., using pixel-by-pixel comparison, using histogram comparison, using machine learning-based comparison, etc.) and if the generated output is within a tolerance threshold of the expected validation output (e.g., 5% difference or less), then the fused main function may be considered to be validated. If validation fails (e.g., the difference between the generated output and the expected validation output exceeds the tolerance threshold), the method 400 may return to step 404 to re-analyze the individual rendering operators and/or may return to step 406 to generate the fused code using a different fusion strategy. The validation may include testing with validation image data that is representative of typical expected image inputs, as well as more challenging validation image data (e.g., very large or very small inputs, unusual rendering contexts, edge boundaries of an image, etc.)

Additional testing and/or optimization may be performed on the fused code. For example, the fused code may be reviewed for any redundant calculations or variables that can be further optimized (e.g., duplicate calculations of the same intermediate results may be removed). The performance of the fused code may also be analyzed. For example, if the performance is slower than expected, the code may be optimized by removing excessive memory allocations or redundant loops. For example, automated compiler tools and analysis may enable the system to automatically test and optimize the fused code without requiring any human intervention. As previously mentioned, a parser may be used to create an AST from the fused code, then data-flow analysis may be used to identify repeated calculations. Common sub-expression elimination (CSE) is another technique that may be used to automatically store and reuse results, to reduce redundant computations. Static analysis in compiler tools (e.g., optimizers for various shading languages) may be used to detect redundant buffer allocations, and memory reuse or allocation merging techniques may be used to consolidate the memory usage. Control-flow analysis may be used to identify unnecessary loops, then loop fusion or invariant code motion techniques may be used to merge or simplify the code loops. Various optimization tools (e.g., SPIR-V optimizers or shader compilers) may be implemented by the operator fusion module 250 to automate transformation between AST and intermediate representation, for example.

In some examples, the fused code may be provided to a human for testing and/or optimization. For example, a human may perform a final review of the code to ensure the fused code is free of errors or performance bottlenecks.

At 416, the fused code may be stored (e.g., in a local storage of the rendering engine 206, or in the storage unit 102 of the computing system 100) and retrievable for future use. For example, fused code that is generated during one runtime instance (e.g., in response to a rendering task request from an instance of an application) may be stored so that the fused code can be used again (e.g., in response to a later rendering task request from the same or different application) without having to regenerate the code from scratch. In another example, the fused code may be generated prior to runtime and may be stored to be retrieved for use at runtime in order to reduce latency during runtime.

At 418, if the fused code was stored at step 416, the fused code may be later retrieved, for example in response to a rendering task request that includes individual rendering operators that have been combined in the fused code. For example, fused code that combines a first rendering operator and a second rendering operator in a given sequence can be retrieved from storage using a query string that contains the first and second rendering operators in that given sequence. Other techniques for storing and retrieving the fused code may be used.

It should be appreciated that the same individual rendering operators may be combined in different sequence order to generate different fused code. As such, if fused code is generated prior to runtime, the query used to retrieve the stored fused code may need to be sensitive to the order in which the individual rendering operators are executed in the fused code. In some examples, where the order in which rendering operators are execute may not be important (e.g., the output generated by applying a blur operator followed by a grayscale operator may not be significantly different than the output generated by applying a grayscale operator followed by a blur operator, when viewed on a small display such as a smartphone), retrieval of the stored fused code may not need to be sensitive to the order. For example, if the rendering task request includes a blur operator followed by a grayscale operator, an attempt may be made to retrieve stored fused code that combines the blur and grayscale operators according to the sequence in the rendering task request. If the retrieval is not successful, another attempt may be made to retrieve stored fused code that combines the blur and grayscale operators in a different sequence instead.

At 420, the fused main function is executed. This causes the individual rendering operators that have been combined to generate the fused code to be applied as a single fused operator (e.g., as a single fused operator task, rather than separate rendering tasks).

Optionally, at 422, the fusion strategy used to generate the fused code may be adjusted based on feedback obtained from monitoring performance of the fused operator. For example, as previously discussed, the performance optimization module 254 may monitor execution of the fused main function and compare the execution with one or more target performance thresholds (e.g., a target execution time, target resource usage, target latency, etc.). If a target performance threshold is not met, the performance optimization module 254 may adjust the fusion strategy and/or send feedback to the operator fusion module 250 to cause the fusion strategy to be adjusted for generating fused code. Adjusting the fusion strategy may include, for example, adjusting the number of individual rendering operators that are combined into the fused code, adjusting the sequence in which the individual rendering operators are executed within the fused code, adjusting which individual rendering operators are combined into fused code, etc.

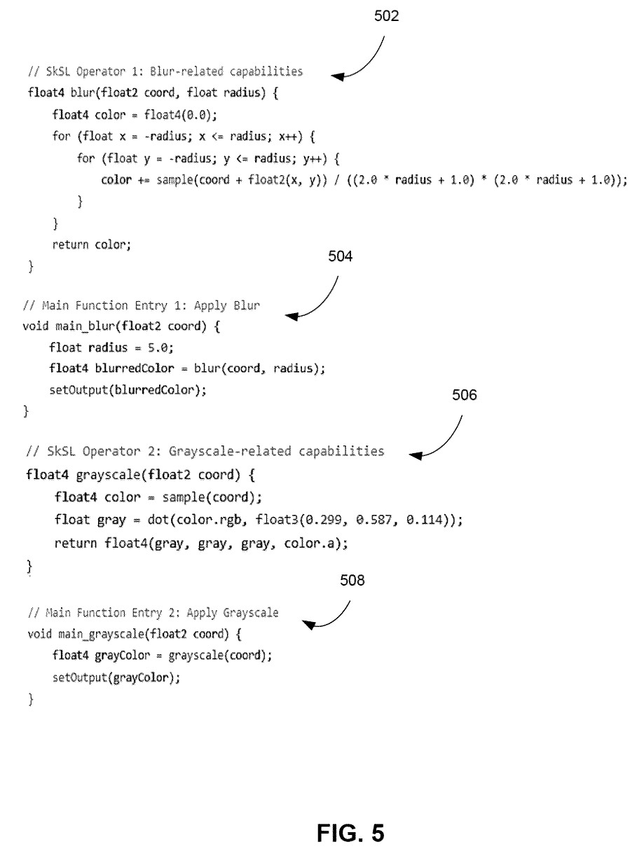

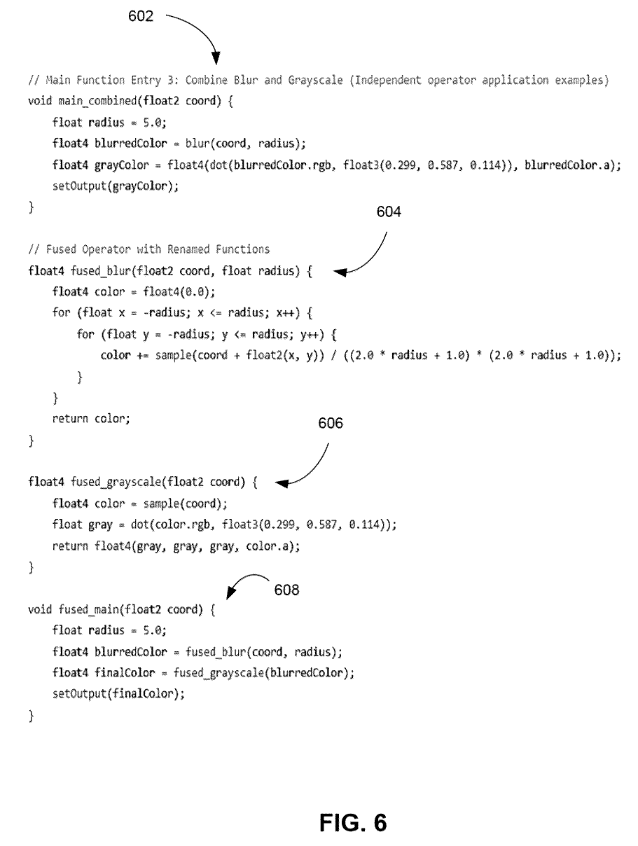

FIG. 5 shows an example of code for two individual rendering operators, in this example a blur operator 502 having a blur main function 504 and a grayscale operator 506 having a grayscale main function 508. FIG. 6 shows an example of fused code 602 resulting from combining the two individual rendering operators using the operator fusion module 250 as disclosed herein. The example fused code 602 includes a renamed blur main function 604, a renamed grayscale main function 606, and the fused main function 608 that is used to call the fused operator. FIGS. 5 and 6 illustrate an example of how the code of the individual rendering operators may be renamed (e.g., by appending “fused” to the main functions of the individual rendering operators) in the fused code, as well as generation of a new fused main function (e.g., fused_main( ) in FIG. 6) that enables the individual rendering operators to be executed in sequence in a single rendering task. In this example, the fused code causes execution of the blur operator followed by the grayscale operator, where the output of the blur operator is provided as input to the grayscale operator. A different set of fused code may cause execution of the grayscale operator followed by the blur operator.

The examples shown in FIGS. 5 and 6 illustrate how the code of individual rendering operators may be analyzed and combined into fused code. For example, as shown in FIG. 5, the blur operator and grayscale operator each has a respective separate main function (blur main function 504 and grayscale main function 508, respectively), indicating the blur and grayscale operators are each designed as individual standalone operations. This modularity enables the operator fusion module 250 to analyze and combine the logic of the operators systematically. The operator fusion module 250 may identify the blur and grayscale operators as candidates to be combined into fused code, for example based on the respective blur and grayscale main functions processing the same type of input (e.g., pixel data). This further indicates that the fused code may be optimized, for example by merging texture reads or combining loops, using various automated analysis and optimization techniques as discussed above. Because the blur and grayscale operators are shader code, it is expected that the code will have certain structure (e.g., GPU-specific elements such as texture sampling, fragment processing, or output to render targets), and the operator fusion module 250 may maintain the structure to ensure that the fused code maintains the proper rendering behavior.

It may be noted that the example of combining blur and grayscale operators illustrate an opportunity for kernel fusion, in which the blur and grayscale operations can be combined into a single shader pass to reduce GPU overhead (e.g., fewer draw calls, lower memory bandwidth). The operator fusion module 250 may also implement automated tools as discussed above (e.g., SPIR-V optimizers), to optimize the fused code for common shader inefficiencies such as redundant loops, excessive temporary variables, unoptimized math operations, etc.

Examples of the present disclosure may be implemented in various rendering applications, including gaming applications, film and animation applications, simulation applications, augmented reality applications, medical imaging applications, virtual reality applications, etc. Examples of the present disclosure may enable high-quality image rendering to be performed in real-time, with reduced latency compared to conventional rendering systems that do not use fused operators. By fusing individual rendering operators into a fused operator, examples of the present disclosure provides technical advantages by reducing the processing time (e.g., the number of passes and/or number of data accesses may be reduced), thus improving latency and frame rate.

Examples of the present disclosure may be implemented in cloud-based platforms, desktop systems, handheld systems, wearable devices, etc. Particularly for handheld or portable computing systems, which may have limited battery power, examples of the present disclosure may help to reduce power consumption.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

It should be understood that examples of the present disclosure may be embodied as a method, an apparatus, a non-transitory computer readable medium, a processing module, a chipset, a system chip or a computer program, among others. An apparatus may include a transmitting module configured to carry out transmitting steps described above and a receiving module configured to carry out receiving steps described above. An apparatus may include a processing module, processor or processing unit configured to control or cause the apparatus to carry out examples disclosed herein.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

What is claimed is:

1. A method comprising:
identifying, for each of two or more individual rendering operators, a respective main function;
generating a set of fused code by combining code of the two or more individual rendering operators, the fused code including a fused main function that, when called, causes the respective main functions of the two or more individual rendering operators to be called in a sequence, the output of a preceding individual operator being provided as input to an immediately following individual operator in the sequence; and
causing the two or more individual rendering operators to be applied as a single fused operator by executing the fused main function.

2. The method of claim 1, further comprising:
receiving a rendering task request, the rendering task request including requests to execute the two or more individual rendering operators;
wherein the identifying is performed responsive to receiving the rendering task request.

3. The method of claim 2, wherein the rendering task request defines the sequence in which the respective main functions of the two or more individual rendering operators are called in the fused code.

4. The method of claim 1, further comprising:
storing the generated fused code;
receiving a rendering task request, the rendering task request including requests to execute the two or more individual rendering operators;
wherein the generated fused code is retrieved and used to cause the two or more individual rendering operators to be applied as the single fused operator, responsive to receiving the rendering task request.

5. The method of claim 4, wherein the rendering task request defines the sequence in which the two or more individual rendering operators are to be called, and the generated fused code is retrieved in response to a query for the two or more individual rendering operators ordered according to the sequence.

6. The method of claim 1, wherein generating the set of fused code comprises:
modifying a function name or a variable name of at least one of the two or more individual rendering operators to be unique within the fused code.

7. The method of claim 1, further comprising:
validating the fused code by executing the fused main function using validation image data as input and comparing output of the fused main function with expected validation output.

8. The method of claim 1, further comprising:
comparing execution of the fused main function with one or more target performance thresholds;
determining that at least one target performance threshold is not met; and
adjusting a fusion strategy used for generating the fused code.

9. The method of claim 8, wherein adjusting the fusion strategy is one of: adjusting a number of individual rendering operators combined into the fused code, adjusting the sequence in which the respective main functions of the two or more individual rendering operators are called within the fused code, or adjusting a selection of individual rendering operators combined into the fused code.

10. A computing system comprising:
a non-transitory memory; and
a processing unit configured to execute instructions stored in the non-transitory memory to cause the system to:
identify, for each of two or more individual rendering operators, a respective main function;
generate a set of fused code by combining code of the two or more individual rendering operators, the fused code including a fused main function that, when called, causes the respective main functions of the two or more individual rendering operators to be called in a sequence, the output of a preceding individual operator being provided as input to an immediately following individual operator in the sequence; and
cause the two or more individual rendering operators to be applied as a single fused operator by executing the fused main function.

11. The system of claim 10, wherein the instructions further cause the system to:
receive a rendering task request, the rendering task request including requests to execute the two or more individual rendering operators;
wherein the identifying is performed responsive to receiving the rendering task request.

12. The system of claim 11, wherein the rendering task request defines the sequence in which the respective main functions of the two or more individual rendering operators are called in the fused code.

13. The system of claim 10, wherein the instructions further cause the system to:
store the generated fused code;
receive a rendering task request, the rendering task request including requests to execute the two or more individual rendering operators;
wherein the generated fused code is retrieved and used to cause the two or more individual rendering operators to be applied as the single fused operator, responsive to receiving the rendering task request.

14. The system of claim 13, wherein the rendering task request defines the sequence in which the two or more individual rendering operators are to be called, and the generated fused code is retrieved in response to a query for the two or more individual rendering operators ordered according to the sequence.

15. The system of claim 10, wherein the instructions cause the system to generate the set of fused code by:
modifying a function name or a variable name of at least one of the two or more individual rendering operators to be unique within the fused code.

16. The system of claim 10, wherein the instructions further cause the system to:
validate the fused code by executing the fused main function using validation image data as input and comparing output of the fused main function with expected validation output.

17. The system of claim 10, wherein the instructions further cause the system to:
compare execution of the fused main function with one or more target performance thresholds;
determine that at least one target performance threshold is not met; and
adjust a fusion strategy used for generating the fused code.

18. The system of claim 17, wherein adjusting the fusion strategy is one of: adjusting a number of individual rendering operators combined into the fused code, adjusting the sequence in which the respective main functions of the two or more individual rendering operators are called within the fused code, or adjusting a selection of individual rendering operators combined into the fused code.

19. A non-transitory computer readable medium storing instructions thereon, wherein the instructions are executable by a processing unit of a computing system to cause the system to:
identify, for each of two or more individual rendering operators, a respective main function;
generate a set of fused code by combining code of the two or more individual rendering operators, the fused code including a fused main function that, when called, causes the respective main functions of the two or more individual rendering operators to be called in a sequence, the output of a preceding individual operator being provided as input to an immediately following individual operator in the sequence; and
cause the two or more individual rendering operators to be applied as a single fused operator by executing the fused main function.

20. The non-transitory computer readable medium of claim 19, wherein the instructions further cause the system to:
compare execution of the fused main function with one or more target performance thresholds;
determine that at least one target performance threshold is not met; and
adjust a fusion strategy used for generating the fused code.
